(19) United States
(12) Patent Application Publication
(10) Pub. No.: US 2006/0146893 A1
(43) Pub. Date: Jul. 6, 2006

(54) Laser

(76) Inventors: Alexey Belyanin, College Station, TX (US); Federico Capasso, Cambridge, MA (US); Mariano Troccoli, Cambridge, MA (US)

Correspondence Address: BERKELEY LAW & TECHNOLOGY GROUP, 1700NW 167TH PLACE, SUITE 240, BEAVERTON, OR, 97006, US

(21) Appl. No.: 11/027,398

(22) Filed: Dec. 30, 2004

(51) Int. Cl. H01S 3/10

(52) U.S. Cl. 372/21

(57) ABSTRACT

Embodiments of a laser are disclosed.

### BACKGROUND

This disclosure is related to lasers.

Semiconductor lasers are a light source in a variety of applications. Examples, without limitation, include compact disc players, scanners, fax machines, and fiber-optic communications to name only a few. Typically, population inversion is employed between electron bands to create lasing action. It has been theorized that lasing action may be possible without population inversion between electron bands being the source of the lasing action. See “Inversionless lasing with self-generated driving field,” appearing in Physical Review A, by Belyanin et al., Volume 64, 013814, 2001; however, in the past, a mechanism was not known to allow this theory to be put into practice.

### BRIEF DESCRIPTION OF THE DRAWINGS

Subject matter is particularly pointed out and distinctly claimed in the concluding portion of the specification. Claimed subject matter, however, both as to organization and method of operation, together with objects, features, and advantages thereof, may best be understood by reference of the following detailed description when read with the accompanying drawings in which:

FIG. 1 is a schematic diagram of embodiments of various multi-level band structures;

FIG. 2 is a schematic diagram of one of the embodiments of FIG.1 shown in more detail;

FIG. 3 is a schematic diagram of an embodiment of a cascaded set of electron transitions and associated band structure;

FIG. 4 is a schematic diagram showing portions of the embodiment of FIG. 3;

FIGS. 5 and 6 are graphs showing experimental results for a representative test sample embodiment of a laser;

FIGS. 7 and 8 are schematic diagrams of alternate embodiments of multi-level band structures; and

FIG. 9 is a set of tables providing information that may be employed for the manufacture of an embodiment of a laser.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail so as not to obscure claimed subject matter.

As alluded to previously, population inversion between energy levels, such as electronic, atomic and/or molecular energy levels, for example, has been viewed in the past as a fundamental aspect in connection with the creation of lasing action, that is, the production of coherent light produced by a device referred to in this context as a laser. Population inversion refers to a situation between energy levels of a material where the, relative population of electrons in the bands is inverted or reversed with respect to an equilibrium condition for the material. Here, the term laser refers to light amplification by stimulated emission of electromagnetic radiation. Likewise, in this particular context, the term light refers to electromagnetic radiation, regardless of whether or not it is visible to the human eye. Stimulated emission of electromagnetic radiation refers to a process in which photons are produced as a result of electron transitions. Although, it had been theorized that lasing action may be possible without population inversion between energy levels being the source of such lasing action, its practical realization has been limited to proof of concept in alkaline atomic vapors. A mechanism to allow this theory to be put into actual practice in semiconductors was not known.

In general, in the area of semiconductor injection lasers, coherent light sources are typically sought that combine tunability with high radiation power, high efficiency, and/or low power consumption. Of course, claimed subject matter is not limited in scope to possessing such advantages. In this context, the term injection laser refers to a laser in which radiation emission occurs at least in part from the injection of electrons into one or more particular electronic energy levels, known as electron bands.

Although claimed subject matter is not limited in scope in this respect, one embodiment of a laser in accordance with claimed subject comprises a nonlinear optical lasing without inversion (LWI) element integrated within an active region of a laser pump. Here, the term active region refers to a portion of a semiconductor device in which injected electrons drift under the action of an electric field applied to the laser device and emit coherent light. Although claimed subject matter is not limited in scope to this particular embodiment, for this particular embodiment, a laser waveguide core comprises a quantum well active region that supports the generation of infrared radiation without inversion on the intersubband transition. Instead of inversion, a mechanism permitting laser amplification is the presence of a coherent optical pump, which is generated in the same active region on another intersubband transition. Thus, this particular embodiment comprises a monolithic integration of a section in which lasing without inversion takes place with an optical pump laser section in the same active region of the semiconductor injection laser. Although claimed subject matter is not limited in scope in this respect, for this particular embodiment, the optical pump laser comprises a quantum cascade (QC) laser used here to produce a coherent optical field.

For this particular embodiment, it is a laser pump or similar coherent optical field drive that at least in part permits lasing without inversion (LWI) to occur. In this context, LWI refers to a quantum-optical phenomenon that may occur in a multi-level electron band structure in the presence of a coherent optical pump or drive, described in more detail below. See, for example, the previously cited article by Belyanin et al. It is likewise noted that an embodiment in accordance with claimed subject matter in which lasing without inversion takes place does not also require or mean that lasing from population inversion cannot occur as well. Claimed subject matter is intended to cover embodiments, such as a laser embodiment, in which lasing without inversion occurs at least in part.

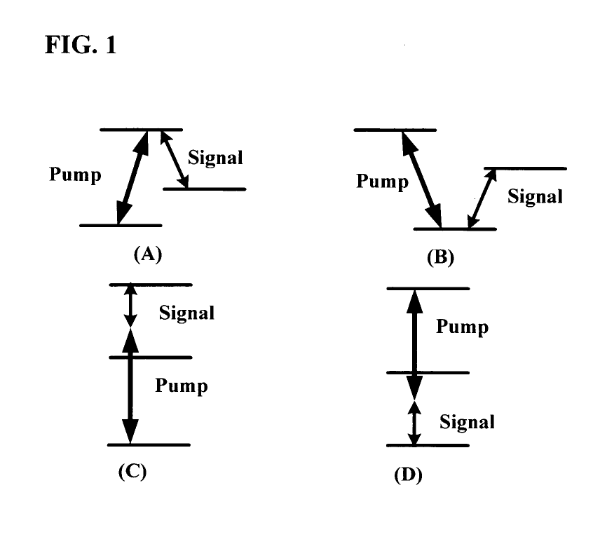

FIG. 1 illustrates several simple three level LWI schemes, although, claimed subject matter is not limited in scope to only the schemes depicted. The particular schemes illustrated in FIG. 1 provide signal gain due at least in part to excitation of coherent polarization at the beat frequency of the pump and signal fields. While these particular schemes all illustrate lasing without inversion, as shall be described in more detail hereinafter, in one embodiment, denoted scheme A in FIG. 1, LWI shall be implemented by employing the Raman effect, described in more detail below. Likewise, schemes C and D in this context are referred to as ladder schemes. The former (C) illustrates a lower ladder scheme and the latter (D) illustrates an upper ladder scheme.

For these particular schemes, under particular conditions, explained in more detail hereinafter, gain or signal amplification may be characterized in a manner similar to relationship [1] below, where 1-3 denotes the pump electron transition and 2-3 denotes the signal electron transition.

$$gain = \{ \frac{g}{{γ}_{32} + {\vert {Ω}_{p} \vert}^{2} / {γ}_{21}} [ \frac{{\vert {Ω}_{p} \vert}^{2} ( {N}_{1} - {N}_{3} )}{{γ}_{21} {γ}_{31}} - ( {N}_{2} - {N}_{3} ) ] \} - losses \qquad [ 1 ]$$

Here Ωₚ=d₁₃Eₚ/η is the Rabi frequency of the optical pump, proportional to the magnitude of the electric field in the pump mode and proportional to the dipole moment of the pump transition; gammas denote the spectral linewidths of the corresponding transitions; factor g is proportional to the dipole moment squared d₂₃². Thus, for such embodiments, gain is related to a difference between a term proportional to the pump field intensity, which comes from coherent oscillations of polarization of the medium excited by the beating of the pump and signal fields, and a term, proportional to N₂- N₃, describing resonant photon absorption of the signal.

For this particular embodiment, however, lasing without inversion may occur in a solid material. Previously, an obstacle to accomplishing lasing without inversion in a solid material related at least in part to resonant absorption of the optical pump. In other words, radiation produced from electron transitions was absorbed into the medium.

In this particular embodiment, although claimed subject matter is not limited in scope in this respect, resonant absorption of the optical pump is overcome by amplification in the optical pump laser section of the active region. Thus, in this particular embodiment, integration of a QC laser with nonlinear optical elements, as described in more detail hereinafter, permits LWI action within a solid material to occur.

Recent developments in mid-to-far infrared and THz sensing and imaging applications indicate a desire for tunable, reliable coherent light sources in this wavelength range. Similarly, advances in secure data communications have made such sources desirable. As shall be discussed further hereinafter, LWI has a potential of extending the wavelength reach of lasers, such as QC lasers, to these ranges potentially at favorable operating conditions, such as high power continuous wave, high temperature operation, while also providing tunability and other advantages, although claimed subject matter is not limit in these respects.

It is noted that oscillators based on the Raman effect, also known as Raman lasers, employ a multi-level system such as illustrated previously in FIG. 1 as scheme A. Hence, the Raman effect is one type of LWI. Typically, such Raman lasers and other LWI schemes implemented before, however, have employed an external optical pump. For this particular embodiment, rather than employing an external optical pump, instead, a nonlinear optical lasing without inversion element, referred to here as a Raman section, is integrated within the active region of a quantum cascade region. For this embodiment, this results in resonant enhancement of the Raman gain, here, by several orders of magnitude.

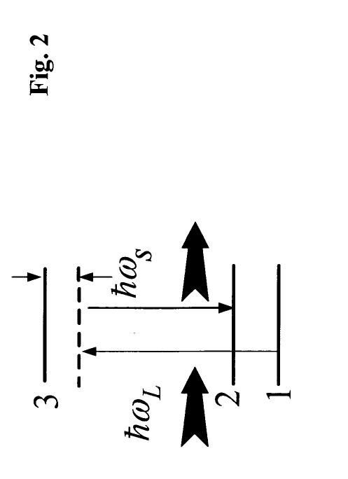

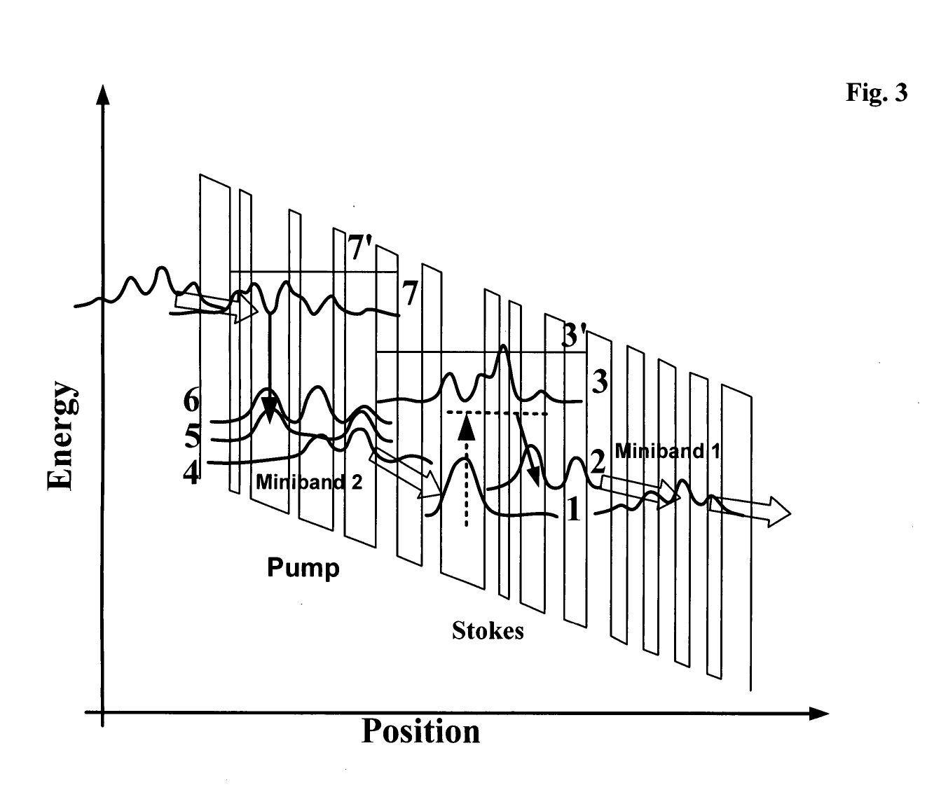

FIG. 2 illustrates a general scheme of a process employing the Raman effect, similar in structure to multi-level scheme A, previously described and illustrated in FIG. 1. In this particular context, signal generated via the Raman effect at a frequency ωₛ is called Stokes radiation, where ωₛ is the Stokes frequency. However, here, as illustrated in FIG. 3, and described in more detail hereinafter, in this particular embodiment of an injection pumped LWI laser, radiation is generated without inversion via electronic transitions, known as intersubband transitions (IST), between confined states in the conduction band of the active region of a quantum cascade (QC) laser. The operation of this particular embodiment shall be described in more detail later, however, here, Raman lasing is due at least in part to the excitation of coherent electron polarization on IST between states one and two. Thus, here, the Raman effect, also referred to as the Raman shift, is of electronic origin and, thus, may vary within a broad range with suitable arrangement of the quantum wells, as described in more detail hereinafter. Likewise, in this embodiment, the intracavity optical pumping scheme makes the process relatively efficient, particularly in comparison with an external optical pump. A reason at least in part is that the a larger portion of the length of the cavity contributes to lasing, in contrast to other potential approaches, since, in this embodiment; intracavity pumping overcomes the usual limitation of exponential attenuation of the external pump. Thus, conversion efficiency from the pump laser to the Raman laser may be achieved, for example, up to ˜30% in one experimental embodiment.

In this particular embodiment, the typical layout of a QC laser has been modified to include, within the same band structure, three intersubband transitions. The band structure is constructed to produce lasing without inversion by applying the Raman effect using scheme A of FIG. 1. In particular, FIG. 3 illustrates the band structure and electron transitions for a multi-stage semiconductor laser device which comprises an injector, a pump region, and a region in which lasing without inversion takes place, also referred to as a Raman section or region, in this particular embodiment.

The pump section in this embodiment, illustrated in FIG. 3, for example, is the so-called “three wells vertical transition” active region, as is sometimes used in state of the art mid-infrared QC lasers. Fundamental radiation, that is, radiation produced by the pump region or section, is generated across electron intersubband transition six to five, where state five is depleted by resonant LO-phonon emission to level four. The energy of the level one to level three transition is somewhat detuned from the pump photon energy to reduce resonant absorption of the pump, as suggested previously, while also taking advantage of the resonant enhancement of the Raman effect. Solution of the density matrix equations and of Maxwell's equations for this embodiment, provides an expression similar to expression [1] above. This expression demonstrates the competition between nonlinear gain from beating between the pump field and the signal field and photon absorption proportional to the difference across transition 3-2.

An aspect of integrating LWI elements with a laser pump, as for this particular embodiment, is related to cascading active regions and injectors, as has, for example, been previously employed in QC lasers. Nonetheless, claimed subject matter is, of course, not limited in scope to employing QC lasers or QC laser related technology. Furthermore, in this context, the term cascade refers to a process in which photons are emitted from one portion of an active region of a semiconductor into another portion of the active region.. However, in this particular embodiment, stacking of QC laser active regions constructed for emission at different wavelengths, along with other quantum structures at least in part takes advantage of vertical current transport as may occur in such laser structures; although, again, claimed subject matter is not limited in scope in this respect. Thus, cascading may be employed in some embodiments to increase power output.

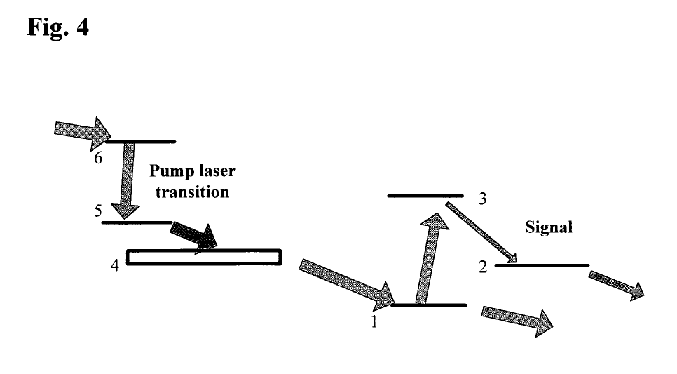

For illustrative purposes, a simplified diagram of the processes occurring in FIG. 3 is shown in FIG. 4. This particular diagram is intended to depict at a high level the processes of cascading electron injection when transitioning in an optical field, as may be employed, for example, in this particular embodiment. Thus, as previously emphasized, in this particular embodiment, a resonant pump and a lasing scheme that employs LWI are implemented in the active region of a QC laser, although this is merely an example embodiment.

As FIG. 4 illustrates, a conventional QC laser cascade of transitions 6-5-4 supports generation of a coherent optical field in a wavelength region between 7 and 9 micometers, as is typical for QC lasers. It is noted here that population inversion does occur across the 6-5 transition; however, such population inversion is not responsible for the lasing without inversion generation of coherent light, as described in more detail hereinafter. Thus, electron injection into upper laser state six and fast depopulation of lower laser state five by LO phonon-resonant scattering to state four, results in population inversion on transition 6-5, as previously indicated. Likewise, as previously described, the quantum well regions are coupled and, thus, adjacent to this QC laser cascade is a system of electron states 1-2-3 to implement the desired Raman effect scheme.

Laser field generation on transition 6-5 serves as a resonant optical drive or pump applied to transition 1-3. Signal is generated on transition 3-2. Thus, there is no population inversion between states 2 and 3 in this embodiment. When the optical drive is present and both fields are at or near resonance with corresponding transitions, signal gain is proportional to expression [1]. Thus, here, Raman lasing overcomes both resonant absorption and non-resonant losses and gives rise to exponential amplification of the signal.

For arbitrary detuning of the pump field from transition 1-3, from expression [1], at least theoretically, maximum gain may be achieved at a frequency given by the difference between the pump frequency and the frequency of transition 1-2, although claimed subject matter is not limited in scope in this respect. If detuning is large, expression [1] simplifies to a relationship provided from standard physics associated with Raman-Stokes scattering with gain being proportional to

$$Raman gain = g \frac{{\vert {Ω}_{p} \vert}^{2} ( {N}_{1} - {N}_{2} )}{{γ}_{21} {Δ}^{2}} - losses \qquad [ 2 ]$$

When the pump is in resonance or near resonance with the 3-1 transition, the Manley-Rowe constraint is overcome and the energy for signal amplification is drawn from the medium or at least in part from it, in particular, for this embodiment, from the population of state three. As has been indicated previously, excitation of large amplitude oscillations of polarization on transition 1-2, also referred to as Raman coherence, as a result of beating of the optical pump and signal fields, allows LWI gain to occur in this particular embodiment.

Note that transition 1-2 is “diagonal” in real space. This suggests that this embodiment may be tuned at least in part by applying a suitable bias voltage across the Raman section. A voltage drop has the capability to shift the energy of the 2-1 transition, perhaps by an amount close to its value with states 1 and 2 being spatially separated by a distance comparable to the width of the section. Thus, for this embodiment, tunable emitters are capable of being implemented using voltage tuning, although claimed subject matter is not limited in scope in this respect. This particular embodiment implements efficient frequency down conversion with the Raman signal having a frequency lower that the pump laser. However, one could perhaps arrange a structure in which state one is higher in energy than state two. Thus, in the latter case, frequency up conversion is possible.

As should now be clear, the previously described embodiment employs stimulated Raman scattering (SRS), a nonlinear optical process that may be implemented in a variety of different media, such as solids, liquids, gases and/or plasmas. In this particular embodiment, for a solid material, gain may be generated at a frequency shifted from that of the incident radiation by an amount corresponding to the frequency of an internal oscillation of the material (the frequency of the 2-1 transition in the embodiment of FIG. 3). As previously noted, this effect is a basis for a class of coherent light sources known as Raman lasers. However, as may be inferred, these sources, in general, have a small gain and employ external laser pumping. In this particular embodiment, the physics of Raman lasing is different from such state-of-the-art Raman lasers. For this embodiment, an enhancement of orders of magnitude in gain is possible. As previously described, this may be based at least in part on triply resonant SRS between quantum confined states within the active region of a quantum cascade laser serving as an internal optical pump. It is additionally worth noting that, in this particular embodiment, the Raman shift is determined at least in part by the energy of an electronic transition between quantum well states, rather than by a phonon energy, as is more commonly the case. As such, an embodiment in accordance with claimed subject matter may be constructed or structured to provide coherent light over a range of wavelengths based at least in part on the thickness of the materials involved, as shall be described in more detail hereinafter. Such an embodiment may therefore combine the advantages of a nonlinear optical device with a semiconductor injection laser, although claimed subject matter is not limited to having such particular advantages.

Relationship or expression [1], previously presented regarding signal gain, for this particular embodiment, provides some insight into structuring or constructing electron bands to accomplish some of the potential benefits previously described, although, claimed subject matter is not limited in scope to employing or having such benefits. In particular, for arbitrary frequency detunings as specified below expression [1] may be rewritten as follows using conventional relationships well-understood in physics and mathematics:

$$g = Re \{ \frac{2 π ω {ⅇ}^{2} {z}_{32}^{2} {z}_{13}^{2} {\vert {E}_{p} \vert}^{2} ( {n}_{1} - {n}_{3} )}{{η}^{3} c ( ( {γ}_{32} + ⅈ δ ) ( {γ}_{21} - ⅈ ( Δ - δ ) ) + {ⅇ}^{2} {z}_{13}^{2} {\vert {E}_{p} \vert}^{2} / {η}^{2} ) ( {γ}_{31} - ⅈ Δ )} - \frac{2 π ω {ⅇ}^{2} {z}_{32}^{2} ( {n}_{2} - {n}_{3} )}{η c ( {γ}_{32} + ⅈ δ + {ⅇ}^{2} {z}_{13}^{2} {\vert {E}_{p} \vert}^{2} / ( {η}^{2} ( {γ}_{21} - ⅈ ( Δ - δ ) ) ) )} \}$$

where Eₚ the electric field amplitude of the pump laser, Z₁₃ is the dipole matrix element of the 1-3 transition, n_{1,2,3} are the electron populations of states 1,2,3, γ's are the total linewidths of the corresponding transitions, and δ and Δ are the detunings of the Raman and laser fields from the transition frequencies ω₃₂ and ω₃₁, respectively. For a gain larger than zero, as is desirable, the first term in brackets should be larger than the second term. From inspection of the expression immediately above, several factors or conditions may make this possible:
(1) an increase in the product of the dipoles z₁₃×z₃₂;
(2) a reduction in the value |z₁₂|²;
(3) a reduction in state 2 lifetime τ₂ for fast depletion of state 2, an increased electron population difference (n₁−n₃), and a decreased population difference (n₂−n₃) by having more of the electronic population in state 1;
(4) a sufficiently large value of electric field amplitude Eₚ (but not too large as |Eₚ|² is also present in the denominator);
(5) a detuning of the laser field; however, this is not apparent from [1], but from numerical calculations—if detuning Δ is equal to 0, too much electron population is transferred to state 3 and then to state 2, and this decreases gain; and
(6) detuning γ=Δ for the Raman field.

These conditions were applied in samples or test devices produced based at least in part upon the calculated band structure shown in FIG. 3. N-type doping of the injector region was employed for a large concentration of electrons in level one. The short lifetime of level two for Raman laser action was achieved by scattering electrons to the multiple states of mini-band one. The estimated matrix elements of the intersubband transitions are z₁₃=1.23 nm, z₂₃=1.31nm, z₁₂=0.7 nm, and the lifetimes are t₃₁=1.9 ps, t₃₂=4.5 ps, t₂₁=5.4 ps, T₂=0.2 ps.

The devices or samples created were based at least in part on the InGaAs/InAlAs heterostructure, grown by molecular beam epitaxy, lattice matched to the InP substrate. LWI in the form of Raman lasing was produced in all of the test samples or devices, although it is noted that traditional lasing may also contribute to photon emission. In this context, an embodiment employs lasing without inversion even if some measurable amount of lasing results from population inversion between electron bands. More specifically, if lasing without inversion is occurring, such a device, system or method, for example, remains within the scope of claimed subject matter, even if lasing is also occurring from population inversion.

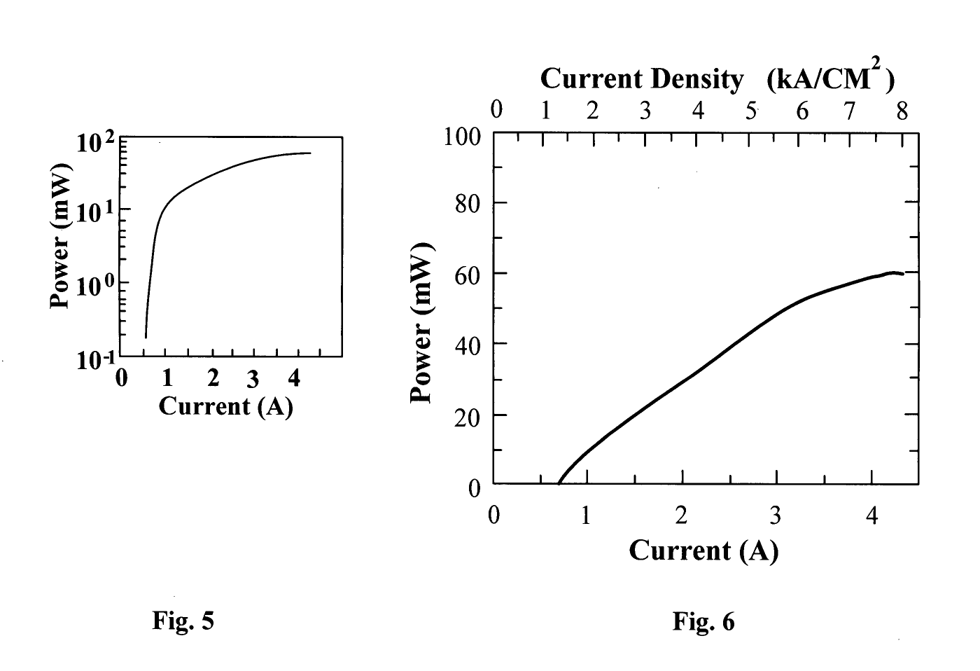

For a representative device, the power output characteristics are displayed in FIG. 5. The measured samples exhibit typically two thresholds, a first one around 1 kA/cm² for the fundamental laser emission and a second one around 4.3 kA/cm² for Stokes radiation emission. The curves shown in the figure represent laser emission “turn on” of fundamental and Stokes radiation. For this particular device, the Stokes radiation emission “turn on” occurs at about an output laser power of 40 milliwatts. At higher currents, the Stokes power reaches about 26% of the fundamental power, where the fundamental emission starts to saturate, as is commonly observed in QC lasers at injection levels of several times the threshold current. Shown in FIG. 6 is the emitted Stokes and fundamental output power as a function of current on a logarithmic scale to emphasize the exponential dependence of radiation emission below threshold as compared with the linear behavior above threshold for both laser lines. For this particular embodiment, therefore, in which both a fundamental laser mode and a Raman Stokes field are generated in the same cascade of intersubband transitions, desirable characteristics, including low thresholds and high conversion efficiencies, are exhibited. Thus, lasers, such as this particular embodiment, may combine the tunability of nonlinear optical devices with the robustness, compact size, and lower power consumption of QC lasers, although claimed subject matter is, of course, not limited in scope in this respect. Likewise, as previously alluded to and described in more detail hereinafter, this approach may also provide the capability for a widely tunable radiation source in the THz range, although, again, claimed subject matter is not limited in scope in this respect. Furthermore, use of internal pumping and/or resonant effects may also be applied in alternative embodiments to enhance the conversion efficiency of other nonlinear optical sources, such as anti-stokes lasers, difference frequency generators and/or parametric oscillators, for example.

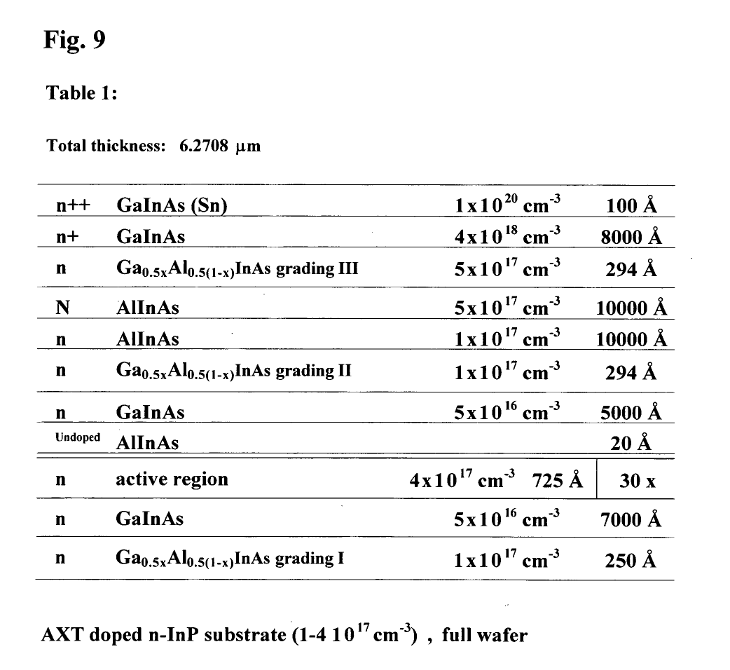

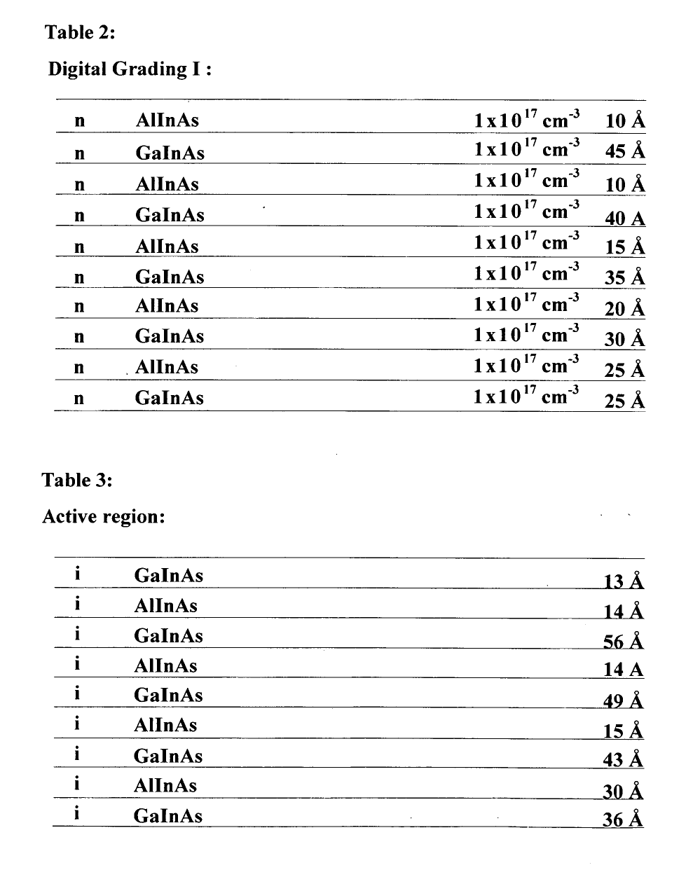

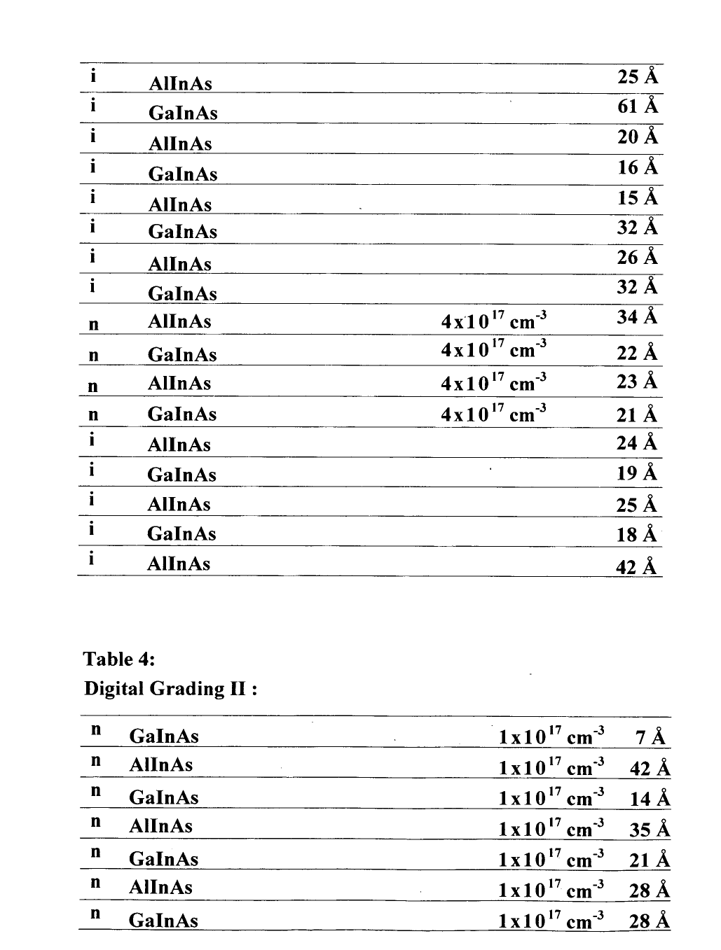

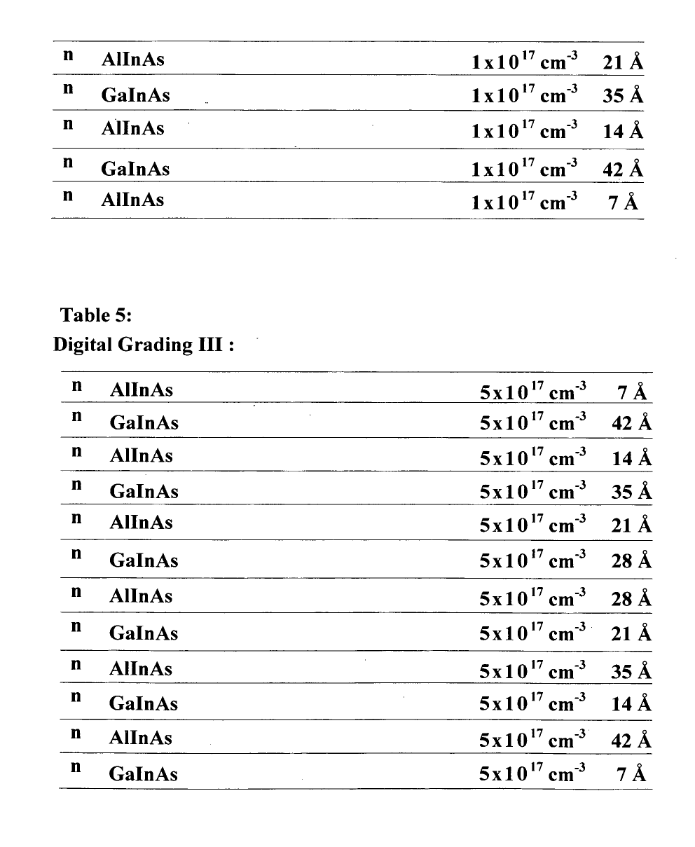

An aspect of this particular embodiment also relates to the manufacture of a semiconductor device to perform desired operations, such as those previously described. Growth here started with a 0.7 μm thick low n-doped (n=5×10¹⁶ cm⁻³) GaInAs layer acting as lower waveguide core, on top of which 30 repetitions of the active region and Raman structure periods were grown. A 0.5 μm GaInAs layer (n=5×10¹⁶ cm⁻³) completes the waveguide core, on top of which an AlInAs cladding layer was grown with a total thickness of 2 μm, in which the first 1 μm was doped to n=1×10¹⁷ cm⁻³, while the rest of it was doped to n=5×10¹⁷ cm⁻³. The topmost layer comprised a highly doped (n=4×10¹⁸ cm⁻³) 0.8 μm thick GaInAs layer for plasmon enhanced confinement, and a final 0.1 nm thick GaInAs contact layer Sn doped with n=1×10²⁰ cm⁻³. The material was processed into ridge waveguides 2.5 mm long and 14-20 μm wide, with a 350 nm thick Si₃N₄ passivating layer on the lateral walls of the ridge and a Ti(30 nm)/Au(300 nm) top contact. A non-alloyed Ge/Au contact was deposited on the back. The samples were Indium-soldered on Ni/Au plated copper holders and mounted in a liquid nitrogen flow cryostat. FIG. 9 includes five tables providing more detailed information regarding the manufacture of these test samples.

Before continuing discussion of alternative embodiments of lasers that may employ LWI lasing, it is worth discussing potential approaches that may be performed in connection with this particular embodiment and with other embodiments that may contribute to wavelength tunability of such embodiments, for example. A variety of methods and/or techniques exist and continue to be developed that contribute to wavelength tunability, for example, and claimed subject matter is not limited in scope to a particular approach either now known or to be later developed.

To be more specific, in lasers, the chemical composition of the active material typically determines at least in part the energy levels between which laser action occurs. This point is reflected in conventional semiconductor lasers. Thus, substantially changing the emitted wavelength typically involves electing other active region materials with different bandgaps. Due at least in part to the nature of QC lasers, however, as one example, wavelengths of light to be produced may be selected over relatively broad ranges by choosing the thickness of the materials in the active region. More specifically, the composition of the materials need not change. For example, such lasers using active region layers of the semiconductor alloys aluminum indium arsenide and gallium indium arsenide, for example, lattice matched to an indium phosphide substrate, and having suitably arranged thicknesses, may be employed to provide emission wavelengths essentially throughout the infrared range and perhaps an even wider range of wavelengths. However, without intending to limit the scope of claimed subject matter, the wavelength of light emitted by QC lasers have also been tuned at least in part based on other approaches, such as thermal tuning and/or applied voltage bias tuning. Thus, it is expected that such techniques may also be useful in connection with tuning the wavelength of light emitted by embodiments within the scope of claimed subject matter.

Without limiting the scope of claimed subject matter, but to understand how material thicknesses may affect this wavelength tuning capability wavelength at least in part, it is helpful to note that, for QC lasers, for example, the optical transition does not occur across the bandgap, as it does in traditional double heterostructure lasers, but rather occurs between discrete electronic states within the conduction band. These states arise from the quantization of electron motion in the active regions. To a good approximation, electrons move freely in the direction parallel to these layers. Discrete energy levels arise, in contrast, from quantizing electron motion in the normal direction. The layers are, therefore, referred to as quantum wells, as has been done previously, by analogy to the potential wells of the well-known particle in a box problem of introductory quantum mechanics. In particular, in both cases, the energy levels depend at least in part on the width of the well. Thus, the energy levels of a quantum well structure may be obtained by numerically solving the Schrödinger equation. By adjusting the width and/or shape of the quantum wells, therefore, one can define an energy level difference that provides within a reasonable approximation a desired emitted wavelength. Likewise, one can improve the matrix element of the optical transition and improve the lifetimes of the quantum well states to achieve the resonant conditions previously described. Designing and/or construction such lasers therefore becomes an exercise in applying techniques of band structure engineering.

Likewise, techniques, such as those described above, may be employed in connection with embodiments of claimed subject matter. For example, and without limitation, such techniques may be employed to tune the wavelength of the laser pump portion of an embodiment. This possibility, therefore, offers the potential for producing a laser embodiment of wide tunability over a spectrum that includes, for example, far infrared and/or Terahertz frequencies, previously unreachable and/or at least challenging to reach. Likewise, this is merely an example of one possible approach to tuning the wavelength of light emitted by an embodiment of claimed subject matter, and other approaches are likewise possible and included within the scope of claimed subject matter.

As indicated above, fabricating such lasers may involve molecular beam epitaxy, a process capable of depositing thin films down to a thickness of one molecular layer. Band structure engineering combined with molecular beam epitaxy, therefore, may provide a role in designing and/or building lasers with the desired tunable electronic and optical properties previously described, although, again claimed subject matter is not limited in scope in this respect. It is also desirable to understand that claimed subject matter is not limited in scope to the previously described materials and/or techniques. A wide variety of well-developed or to be later developed heterostructure materials and/or manufacturing techniques may be employed to produce embodiments in accordance with claimed subject matter. For example, devices may be implemented in a broad variety of technologically well developed heterostructure materials, such as, for example:

1. AlInAs/GaInAs lattice matched to InP.

2. Strain compensated AllnAs/GaInAs in which in a stage, such as, for the previously described embodiment of an injector, a pump section and Raman section, the total tensile strain equals the compressive strain. This allows a larger quantum well depth with greater wavelength tailorability.

3. InP/InGaAsP lattice matched to InP.

4. AlGaAs/GaAs.

5. AlGaN/InGaN

The above are example materials systems and those skilled in the art will understand that claimed subject may be implemented in other materials, such as combinations using Group IIII-Group V elements of the periodic table, for example InAs, GaAs, InP, AlAs, InSb, GaSb, AlSb, GaP and/or their tertiary and/or quaternary combinations. Likewise, the above material systems may be grown with, for example, Molecular Beam Epitaxy and/or Metal-organic Vapor Phase Epitaxy growth technology. Likewise, device manufacturing techniques include, as examples, and not intending to limit the scope of claimed subject matter, photolithography, etching and/or metallization technology.

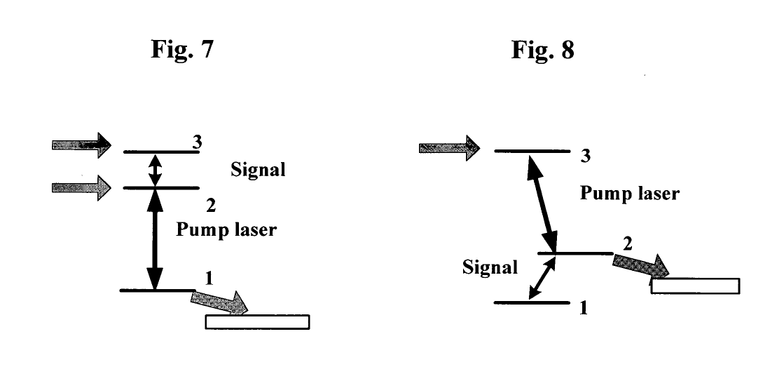

In the previously described embodiment, an approach was employed in which the optical field pump and LWI signal were generated in adjacent, but physically different, coupled quantum well active regions. That approach has some advantages in that the laser pump and LWI active regions may be separately arranged, adding flexibility; however, they may also compete for overlap with the optical modes in the waveguide. Thus, in an alternate embodiment, at least in part to address the latter issue, both the optical pump and signal field may be generated in the same coupled-quantum well active region so that the pump laser transition serves as one leg of the LWI cascade. This latter embodiment has an advantage of using more of the waveguide core for both the pump laser gain and the LWI process, although a trade off may exist between laser pump performance and the LWI gain. FIGS. 7 and 8 illustrate two vertical cascade schemes that may provide LWI gain: upper and lower ladder schemes.

In the lower ladder scheme of FIG. 7, the optical pump field is generated on transition 2-1. There is population inversion between states two and one due at least in part to a fast depletion of state one and relatively long lifetime of state two. The laser field generated on transition 2-1 provides a coherent field for LWI on a fast decaying transition 3-2. Block arrows show the injection current of electrons. In the upper ladder scheme of FIG. 8, the roles of transitions 1-2 and 2-3 are interchanged. Now, transition 3-2 is inverted and supports laser action, while the signal is generated on transition 1-2 in absence of population inversion due at least in part to a short lifetime of state two. In both schemes, improved gain may be achieved at resonance with the particular transitions, that is, transition 3-2 for the former and transition 2-1 for the latter. The pump field is at resonance with corresponding laser transitions. Its wavelength is within the range of QC lasers. Both frequency up conversion and down conversion are possible in both schemes.

An embodiment in accordance with claimed subject matter may also employ a diffraction grating, although claimed subject matter is not limited in scope in this respect. Such a grating may be used to select one or a limited number of particular modes of the cavity for lasing. In one embodiment, the period of such a grating, d, may be employed to select the wavelength by satisfying the Bragg condition λ=2n_{eff}d, where n_{eff} is the effective refractive index of the waveguide. In this particular embodiment, light whose wavelength satisfies the Bragg condition may be reflected off the grating and so may be selected for laser action.

It will, of course, be understood that, although particular embodiments have just been described, claimed subject matter is not limited in scope to a particular embodiment or implementation. For example, one embodiment may be in hardware, such as implemented to operate on a device or combination of devices, for example, whereas another embodiment may be in software. Likewise, an embodiment may be implemented in firmware, or as any combination of hardware, software, and/or firmware, for example. Likewise, although claimed subject matter is not limited in scope in this respect, one embodiment may comprise one or more articles, such as a storage medium or storage media. This storage media, such as, one or more CD-ROMs and/or disks, for example, may have stored thereon instructions, that when executed by a system, such as a computer system, computing platform, or other system, for example, may result in an embodiment of a method in accordance with claimed subject matter being executed, such as one of the embodiments previously described, for example. As one potential example, a computing platform may include one or more processing units or processors, one or more input/output devices, such as a display, a keyboard and/or a mouse, and/or one or more memories, such as static random access memory, dynamic random access memory, flash memory, and/or a hard drive.

In the preceding description, various aspects of claimed subject matter have been described. For purposes of explanation, specific numbers, systems and/or configurations were set forth to provide a thorough understanding of claimed subject matter. However, it should be apparent to one skilled in the art having the benefit of this disclosure that claimed subject matter may be practiced without the specific details. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all such modifications and/or changes as fall within the true spirit of claimed subject matter.

1. A device comprising: an injection laser;
wherein said injection laser comprises a non-linear optical LWI element integrated within an active region of a laser pump.

2. The device of claim 1, wherein said laser pump comprises a quantum cascade laser pump.

3. The device of claim 2, wherein said non-linear optical LWI element is structured to implement the Raman effect.

4. The device of claim 2, wherein said non-linear optical LWI element is structured to implement a ladder scheme.

5. The device of claim 4, wherein said ladder scheme comprises one of an upper ladder scheme or a lower ladder scheme.

6. The device of claim 1, wherein said injection laser comprises multiple stages, at least one stage comprising a non-linear optical LWI element integrated within an active region of a laser pump.

7. The device of claim 1, wherein said non-linear optical LWI element is adapted to generate lasing via electronic intersubband transitions (IST).

8. The device of claim 1, wherein the thickness of materials affects the configuration of quantum wells within said injection laser to determine at least in part the wavelength of light emitted by said injection laser.

9. The device of claim 1, and further comprising a diffraction grating to select a particular wavelength of light to emit.

10. The device of claim 1, wherein said non-linear optical LWI element integrated within an active region of a laser pump comprises a combination of materials using Group IIII-Group V elements of the periodic table.

11. The device of claim 10, wherein said combination of materials includes one or more nitrides.

12. The device of claim 10, wherein said combination of materials includes at least one of: InAs, GaAs, InP, AlAs, InSb, GaSb, AlSb and/or GaP.

13. The device of claim 12, wherein said combination of materials includes at least one of the tertiary and/or the quaternary combinations of InAs, GaAs, InP, AlAs, InSb, GaSb, AlSb and/or GaP.

14. The device of claim 1, wherein said injection laser is capable of emitting light at least approximately in the spectrum from near infrared to far infrared light and/or at least approximately in the terahertz frequency range.

15. A method comprising:
generating a coherent optical field; and
amplifying a signal created by an electron transition without population inversion, the amplification due at least in part to said coherent optical field.

16. The method of claim 15, wherein said coherent optical field is generated via electron state transitions.

17. The method of claim 16, wherein said coherent optical field is generated by one quantum well and signal amplification is generated by another quantum well; said quantum wells being adjacent in an active region of an integrated device.

18. The method of claim 16, wherein said coherent optical field is generated by a QC laser pump structure producing said electron state transitions.

19. The method of claim 15, wherein the signal amplification comprises lasing.

20. The method of claim 19, wherein said lasing is generated by the Raman effect.

21. The method of claim 15, wherein said electron state transition creating said signal and said coherent optical field are generated within one quantum well in an active region of an integrated device.

22. A method of manufacturing a laser device comprising:
growing doped and/or undoped semiconductor layers to form the active region of a laser pump; wherein said doped and/or undoped semiconductor layers further integrate a non-linear optical LWI element within said active region.

23. The method of claim 22, wherein said growing comprises molecular beam epitaxy.

24. The method of claim 22, wherein said growing comprises metal-organic vapor phase epitaxy deposition.

25. The method of claim 22, wherein said layers are grown to particular thicknesses to affect the configuration of quantum wells within said laser device to determine at least in part the wavelength of light to be emitted.

26. The method of claim 22, wherein said semiconductor layers are grown over a substrate.

27. The method of claim 22, wherein said non-linear optical LWI element integrated within said active region comprises a combination of materials using Group IIII-Group V elements of the periodic table.

28. The method of claim 27, wherein said combination of materials includes one or more nitrides.

29. The method of claim 27, wherein said combination of materials includes at least one of: InAs, GaAs, InP, AlAs, InSb, GaSb, AlSb and/or GaP.

30. The method of claim 29, wherein said combination of materials includes at least one of the tertiary and/or the quaternary combinations of InAs, GaAs, InP, AlAs, InSb, GaSb, AlSb and/or GaP.

31. A laser device produced by a manufacturing process, said process comprising:
growing doped and/or undoped semiconductor layers to form the active region of a laser pump; wherein said doped and/or undoped semiconductor layers further integrate a non-linear optical LWI element within said active region.

32. The laser device of claim 31, wherein said growing comprises molecular beam epitaxy.

33. The laser device of claim 31, wherein said growing comprises metal-organic vapor phase epitaxy deposition.

34. The laser device of claim 31, wherein said layers are grown to particular thicknesses to affect the configuration of quantum wells within said laser device to determine at least in part the wavelength of light to be emitted.

35. The laser device of claim 31, wherein said semiconductor layers are grown over a substrate.

36. The laser device of claim 31, wherein said non-linear optical LWI element integrated within said active region comprises a combination of materials using Group IIII-Group V elements of the periodic table.

37. The laser device of claim 36, wherein said combination of materials includes one or more nitrides.

38. The laser device of claim 36, wherein said combination of materials includes at least one of: InAs, GaAs, InP, AlAs, InSb, GaSb, AlSb and/or GaP.

39. The laser device of claim 38, wherein said combination of materials includes at least one of the tertiary and/or the quaternary combinations of InAs, GaAs, InP, AlAs, InSb, GaSb, AlSb and/or GaP.

40. A laser comprising
means for generating a coherent optical field; and
means for amplifying a signal created by an electron transition without population inversion, the amplification due at least in part to the coherent optical field.

41. The laser of claim 40, wherein said means for generating coherent optical field comprises means for generating electron transitions.

42. The laser of claim 40, wherein said means for generating a coherent optical field comprises a quantum cascade laser pump.

43. The laser of claim 40, wherein said means for amplifying a signal comprises means for lasing.

44. The laser of claim 43, wherein said means lasing is adapted to generate the lasing via the Raman effect.
